(19) United States
(12) Patent Application Publication
(10) Pub. No.: US 2015/0043998 A1
(43) Pub. Date: Feb. 12, 2015

(54) PRINT MEDIA MOISTURIZING UNIT

(71) Applicant: OCE-TECHNOLOGIES B.V., Venlo (NL)

(72) Inventors: Willem P.H.A. JANSSEN, Venlo (NL); Eric P.A. DRIESSEN, Broekhuizenvorst (NL)

(73) Assignee: OCE-TECHNOLOGIES B.V., Venlo (NL)

(21) Appl. No.: 14/522,705

(22) Filed: Oct. 24, 2014

Related U.S. Application Data
(63) Continuation of application No. PCT/EP2013/057985, filed on Apr. 17, 2013.

(30) Foreign Application Priority Data
Apr. 27, 2012 (EP) 12165865.2

(51) Int. Cl. B42C 19/02; B41J 11/00

(52) U.S. Cl. CPC B42C 19/02; B41J 11/0015
USPC 412/33; 347/101

(57) ABSTRACT

Print media moisturizing unit, comprising a first print media guidance member and a second print media guidance member, said first print media guidance member and second print media guidance member defining a print media transport path for transporting subsequent print media sheets at a distance from each other, further comprising a first substantially planar spray assembly for supplying a spray in a first plane and a second substantially planar spray assembly for supplying a spray in a second plane, wherein the first substantially planar spray assembly and the second substantially planar spray assembly are configured such that the first plane and the second plane intersect outside the print media transport path.

### FIELD OF THE INVENTION

The present invention generally pertains to a print media moisturizing unit. The present invention further pertains to a post-processing device, a printing system and a book production system, comprising such a print media moisturizing unit.

### BACKGROUND ART

Print media moisturizing units are known as such. In book production systems it is common to use webs of print media, also known as continuous feed printers. In a known printing system a web of print media is sprayed single sided in a continuous fashion to homogeneous apply an amount of moisture, usually water, to condition the moisture content of a web. In a specific embodiment of a known web printing system, two moisturizing units are present, oriented on both sides of the web of print media at the same position of the print media path, spraying water on opposite sides of the passing print media.

The web of print media separates the two streams of water and absorbs the amount of moisture. In case the two streams of water intersect, drops are formed and the print media transport path may get flooded with moisture.

### SUMMARY OF THE INVENTION

In an aspect of the present invention, a print media moisturizing unit is provided. The print media moisturizing unit comprises a first print media guidance member and a second print media guidance member, said first print media guidance member and second print media guidance member defining a print media transport path for transporting subsequent print media sheets at a distance from each other, further comprising a first substantially planar spray assembly for supplying a spray in a first plane and a second substantially planar spray assembly for supplying a spray in a second plane, wherein the first substantially planar spray assembly and the second substantially planar spray assembly are configured such that the first plane and the second plane do not intersect inside the print media transport path.

A print media guidance member is a member such as a metal plate or e.g. bend rods configured to guide a print media on its way along the several stations. In case of a metal plate, holes are provided to allow transport nips to transport the sheet of print media and further apertures are provided to allow to the spray to pass from the spray assembly towards the sheet of print media. The volume between the first and second print media guidance member is defined as print media transport path. The planar spray assembly supplies a spray of moisture in a direction extending substantially in a planar fashion. In practise a small amount of the spray may escape and follow another trajectory, but the main direction of the spray is substantially planar. Subsequent sheets print media at a distance from each other, separate sheets of print media, such as paper sheets e.g. A4, A3, Legal, or any other commonly used sheet of print media. The print media guidance member may include threads or small spokes extending substantially in direction of transport of the sheets to allow for a more robust transport of sheets, in particular in cases where sheet of print media obtain a reduces stiffness after passing the spray means, as is the case in most commonly known sheets of paper.

The first and second substantially planar spray assemblies are configured such that the first plane, originating from the first substantially planar spray assembly does not intersect the second plane, originating from the first substantially planar spray assembly inside the print media transport path, i.e. between said first and second print media guidance members. The spray planes are the imaginary planes along which the main spray extends from the substantially planar spray assembly. Whereas the system transports separate sheets of print media at some distance from each other, the first and second sprays might meet and form some amount of moisture drops at the intersection of the planes or the existing drops from the spray collide into a trajectory towards the print media transport path.

In an embodiment the first plane and the second plane intersect outside the print media transport path. By configuring the first and/or second substantially planar spray assembly such that the planes of spray intersect outside the volume defines between the first and second print media guidance members, e.g. at the opposite side of the first or second print media guidance member with respect to the print media transport path, the drops of moisture originating from the intersection of the spray planes do not pass into the print media transport path where they may damage sheets of print media due to over flooding a sheet downstream or down gravitational direction.

In another embodiment the first plane and the second plane are oriented substantially parallel at an offset to each other. Spraying the print media from opposite sides of the sheet the first and second spray planes do not intersect, and in particular not inside the volume containing the print media transport path.

In an embodiment the first substantially planar spray assembly is mounted on a first side of the print media transport path and the second substantially planar spray assembly is mounted on a second side op the print media transport path opposite to said first side with respect to a sheet of print media in between the first and second spray assemblies such that both sides are providable with some amount of moisture spray from the spray assemblies.

In an embodiment the first and second substantially planar spray assembly comprise a rotatable disk, oriented in respectively the first and second plane. By spinning said rotatable disk while dropping an amount of moisture onto the spinning disks a substantially planar spray originates from the spinning disk in a main planar direction substantially equal to the planar orientation of the disk. By providing a certain aperture in the print media guidance member a certain portion of the plane of moisture spray shall reach the print media transport path. The rest of the moisture spray shall bounce of the print media guidance member and can alternatively be collected for future application.

In a further embodiment, said print media moisturizing unit further comprises water supply means for controllably supplying water onto the rotatable disk of respectively the first and second substantially planar spray assembly. A commonly known water pump with a stretch of hose of flexible pipe may drop-wise or in a continuous flow apply water onto the spinning disks.

In an embodiment the print media moisturizing unit further comprises means for determining an absence of a sheet between the first and second substantially planar spray assemblies and wherein the supply of the spray in respectively the first and second plane is reduced if no sheet is present between the first and second substantially planar spray assemblies. Whereas spray of moisture is in most cases undesired if no sheet is present between said first and second spray means, it is advantageous to determine whether or not a sheet is present and to reduce the amount of spray if no sheet is present, e.g. when a gap between the sheets passes along the spray means. This reduction may also be a reduction to substantially no spray at all, e.g. by valves or shutters at the spray means or at the apertures in the print media guidance members.

In an embodiment the print media moisturizing unit further comprises means for determining a measure associated with the amount of curl in a sheet between the first and second substantially planar spray assemblies and wherein the supply of the spray in respectively the first and second plane is adjustable to correct for the amount of curl in a sheet between the first and second substantially planar spray assemblies. In commonly known printing processes a certain amount of heat energy is applied on the print media. This may result in the introduction of a certain amount of curl to the print media. Also the marking substance itself, may e.g. be aqueous and therefore introduce a difference in moisture content between the front and back side of the sheet, and therefore result in curl. By controlling the spray means such that the first and second spray means supply a different amount of moisture at the print media moisturizing unit, the amount of curl may be reduced or even be dismissed.

The print media moisturizing unit is applied very advantageous in a separate post-processing unit, e.g. connectable to a print engine, such that printed sheets are post-processed to control the moisture content of print media.

The print media moisturizing unit may be advantageously applied in print systems, e.g. before or after applying a marking substance to the sheet of print media.

In a book production system, comprising a printing system and a book binding station configured to collect sheets of processed print media and to subsequently bind the sheets of processed print media to form a book it is important to condition printed sheets of print media such that sheets do not cockle after binding the separate sheets into a book or book block. In particular when books are bind and thereafter cut into defined sizes cockling and edge waves are very easily observed by users. Further disadvantage of such system is that this cockling and waviness typically start a few days after printing. In print-on-demand type of environments, a book is produced and sent to customers right away, such that when the customer receives a book by postal services, this deficiency may lead to additional costs for the book producer. By controlling the moisture content by means of the print media moisturizing unit of print media, in particular paper sheets, cockling may be diminished significantly.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given herein below and the accompanying schematical drawings which are given by way of illustration only, and thus are not limitative of the present invention, and wherein:

FIG. 1 schematically illustrates a moisture spray source;

FIG. 2 schematically illustrates a cross-sectional view of a print media moisturizing unit according to the present invention;

FIG. 3 shows schematically illustrates a cross-sectional view of a print media moisturizing unit according to the present invention;

FIG. 4 schematically illustrates a perspective view of a print media moisturizing unit according to the present invention;

### DETAILED DESCRIPTION OF THE DRAWINGS

The present invention will now be described with reference to the accompanying drawings, wherein the same reference numerals have been used to identify the same or similar elements throughout the several views.

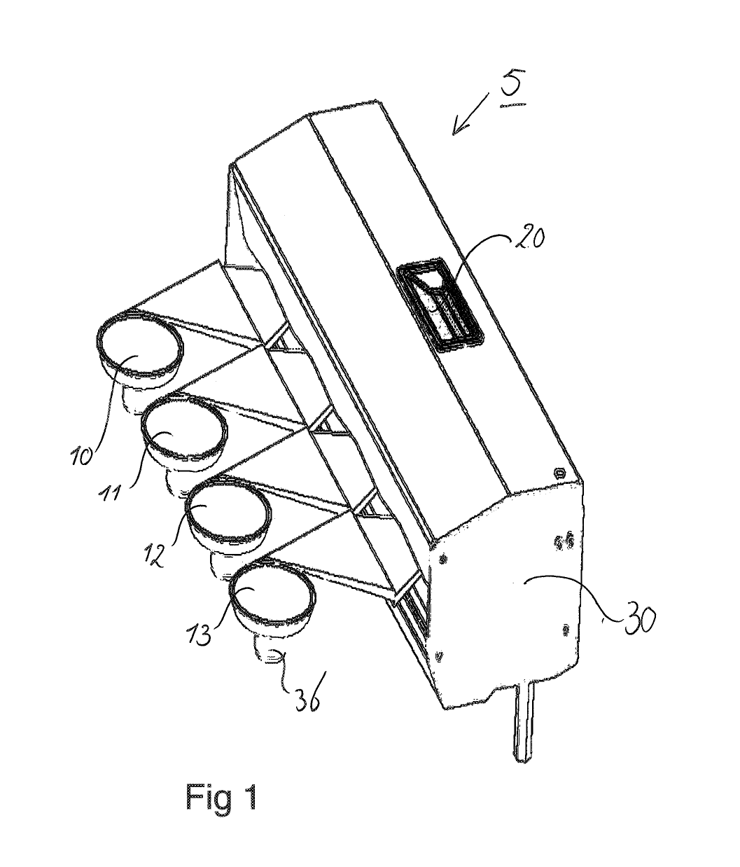

FIG. 1 schematically illustrates a moisture spray source 5. Moisture, in this embodiment water, is supplied to the moisture spray source 5 via inlet 20. inside the spray body 30 this inlet is split into four branches by means of a flexible rubber hose. This hose is connected to a pump (not shown) which pumps drops of water onto the center of spinning disks 10, 11, 12, 13. These disks are rotatably mounted and driven by an electric motor 36. The pump is controllable such that the amount of water supply is controllable and therefore the amount of spray is controllable.

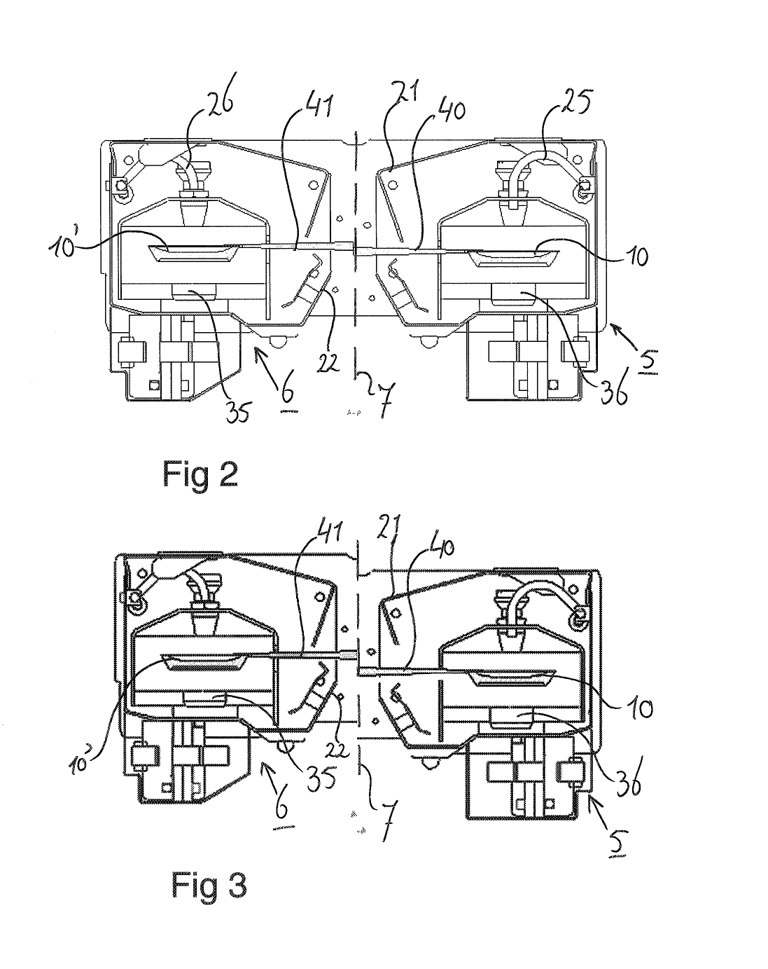

FIG. 2 schematically illustrates a cross-sectional view of a print media moisturizing unit according to the present invention. A first moisture spray source 5 and a second moisture spray source 6 are provided. The moisture spray sources 5, 6 comprise a spinning disk 10, 10′ driven by a motor 35, 36. An amount of water is supplied onto these disks by means of a rubber hose 26, 26 connected to a water reservoir (not shown) and a water pump. By supplying an amount of water onto the spinning disks, a substantially planar spray of water 40, 41 is ejected from the disks, substantially in the planar direction of the spinning disks. In this embodiment, the first and second substantially planar sprays are directed such that they intersect on the left side of print media guidance member 22 where the excess of water is collected for re-use. It will be clear that alternatively the sprays may intersect at the other side of the other print media guidance member 21. In particular the sprays are configured such that they do not intersect inside the print media transport path 7, defined as the volume between the first and second print media guidance members 21, 22. A sheet of print media is transported along the print media transport path 7 through the volume in between the first and second print media guidance members 21, 22 along the first and second spray sources 5, 6. Apertures in the print media guidance members 21, 22 arrange for a pass-through of the sprays 40, 41 from the spray sources 5, 6 towards the print media in the print media transport path 7.

FIG. 3 schematically illustrates a cross-sectional view of a print media moisturizing unit according to the present invention. A first moisture spray source 5 and a second moisture spray source 6 are provided. The moisture spray sources 5, 6 comprises a spinning disk 10, 10′ driven by a motor 35, 36. An amount of water is supplied onto these disks by means of a rubber hose 26, 26 connected to a water reservoir (not shown) and a water pump. By supplying an amount of water onto the spinning disks, a substantially planar spray of water 40, 41 is ejected from the disks, substantially in the planar direction of the spinning disks. In this embodiment, the first and second substantially planar sprays are directed substantially parallel to each other and have an offset, such that they do not intersect inside the print media transport path 7, defined as the volume between the first and second print media guidance members 21, 22. A sheet of print media is transported along the print media transport path 7 through the volume in between the first and second print media guidance members 21, 22 along the first and second spray sources 5, 6. Apertures in the print media guidance members 21, 22 arrange for a pass-through of the sprays 40, 41 from the spray sources 5, 6 towards the print media in the print media transport path 7.

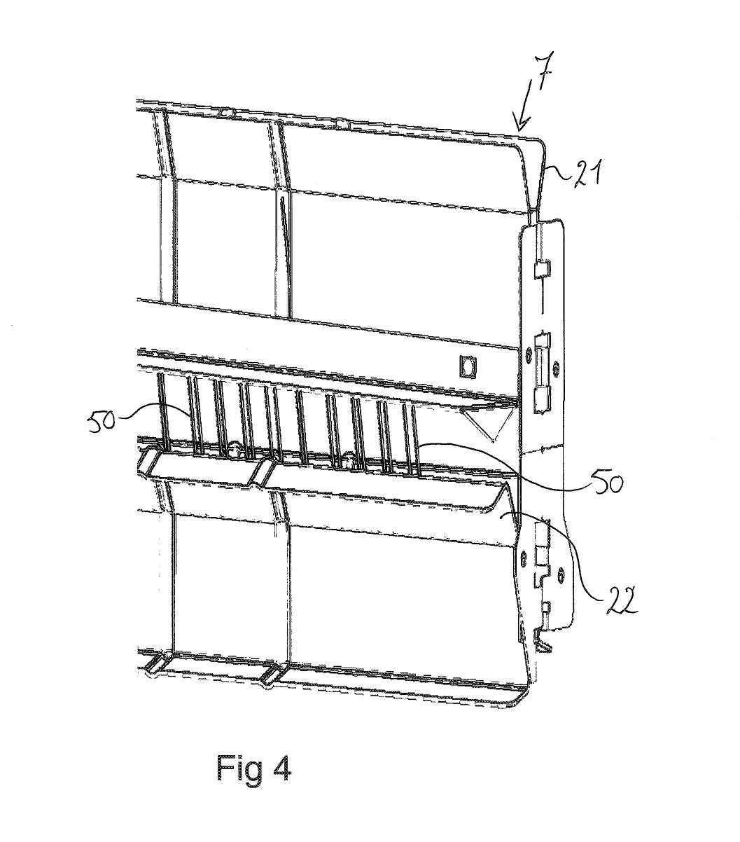

FIG. 4 schematically illustrates a perspective view of a print media moisturizing unit according to the present invention. The spray sources are left out in the illustration for reasons of clarity. The print media transport path 7 as defined between the first print media guidance member 21 and the second print media guidance member 22 is configured to receive sheets of paper, such as a sheet of plain paper A4 (not shown). Strings 50 extend from the entrance of the print media transport path towards the exit in direction of transport of a sheet and assist the transport of said sheet during its transport thought the unit. This is in particular useful in case a sheet of paper is sprayed with water which normally reduces its stiffness in transport direction. The strings 50 support the sheet while transported, and do not substantially interfere with the sprays through the apertures in the print media guidance members.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. Print media moisturizing unit, comprising:
a first print media guidance member and a second print media guidance member, said first print media guidance member and second print media guidance member defining a print media transport path for transporting subsequent print media sheets at a distance from each other; and
a first substantially planar spray assembly for supplying a spray in a first plane and a second substantially planar spray assembly for supplying a spray in a second plane, wherein the first substantially planar spray assembly and the second substantially planar spray assembly are configured such that the first plane and the second plane do not intersect inside the print media transport path.

2. The print media moisturizing unit according to claim 1, wherein the first plane and the second plane intersect outside the print media transport path.

3. The print media moisturizing unit according to claim 1, wherein the first plane and the second plane are oriented substantially parallel to each other.

4. The print media moisturizing unit according to claim 1, wherein the first substantially planar spray assembly is mounted on a first side of the print media transport path and the second substantially planar spray assembly is mounted on a second side op the print media transport path opposite to said first side.

5. The print media moisturizing unit according to claim 1, wherein the first and second substantially planar spray assembly comprise a rotatable disk, oriented in respectively the first and second plane.

6. The print media moisturizing unit according to claim 5, further comprising water supply means for controllably supplying water onto the rotatable disk of respectively the first and second substantially planar spray assembly.

7. The print media moisturizing unit according to claim 1, further comprising a device configured to determine an absence of a sheet between the first and second substantially planar spray assemblies and wherein the supply of the spray in respectively the first and second plane is reduced if no sheet is present between the first and second substantially planar spray assemblies.

8. The print media moisturizing unit according to claim 1, further comprising a device configured to determine a measure associated with the amount of curl in a sheet between the first and second substantially planar spray assemblies and wherein the supply of the spray in respectively the first and second plane is adjustable to correct for the amount of curl in a sheet between the first and second substantially planar spray assemblies.

9. A post-processing device for post-processing print media, comprising:
a print media input station;
a print media output station; and
the print media moisturizing unit according to claim 1.

10. A printing system, comprising:
a media supply station for supplying subsequent print media sheets along a print media transport path;
a printing station arranged along the print media transport path for applying an image onto the print media; and
the print media moisturizing unit according to claim 1.

11. A book production system, comprising:
the printing system in accordance to claim 10; and
a book binding station configured to collect sheets of processed print media and to subsequently bind the sheets of processed print media to form a book.
